(19) United States
(12) Patent Application Publication
(10) Pub. No.: US 2026/0184172 A1
(43) Pub. Date: Jul. 2, 2026

(54) AUGMENTED-REALITY ASSISTANCE TO IMPROVE TRAFFIC MARKERS

(71) Applicant: AT&T Intellectual Property I, L.P., Atlanta, GA (US)

(72) Inventors: Eric Zavesky, Austin, TX (US); Ginger Chien, Bellevue, WA (US); Zhi Cui, Sugar Hill, GA (US)

(21) Appl. No.: 19/001,907

(22) Filed: Dec. 26, 2024

(51) Int. Cl. B60K 35/28; B60K 35/235; B60K 35/85

(52) U.S. Cl. CPC B60K 35/285; B60K 35/235; B60K 35/85; B60K 2360/177; B60K 2360/1868; B60K 2360/191; B60K 2360/5915; B60K 2360/592; B60K 2360/741

(57) ABSTRACT

A method includes monitoring at least one environmental condition surrounding a vehicle, using at least one on-board sensor of the vehicle, detecting that the at least one environmental condition surrounding the vehicle is likely to impair a visibility for an occupant of the vehicle, based on an output of the at least one on-board sensor, acquiring static map data for a location surrounding the vehicle, generating an augmented reality view of the location surrounding the vehicle, using the static map data for highlighting at least one traffic marker at the location surrounding the vehicle, and displaying the augmented reality view of the location surrounding the vehicle with the at least one traffic marker being highlighted on a display within the vehicle is disclosed.

The present disclosure relates generally to augmented reality, and relates more particularly to systems, non-transitory computer-readable media, and methods for using augmented reality to improve visibility of traffic markers to assist drivers in navigating driving conditions in which the drivers'visibility may be impaired due to the traffic markers being occluded or obstructed.

### BACKGROUND

Augmented reality (AR) is a specific instance of extended reality technology in which computer-generated virtual objects may be inserted into a view of a real world environment. For instance, a computer generated overlay may be superimposed over an image of a real world environment in order to present an AR experience. Thus, AR may be used to provide immersive entertainment experiences (e.g., gaming, movies, or the like), to simulate conditions for training exercises (e.g., for emergency responders, medical personnel, or the like), to improve e-commerce experiences (e.g., by enabling shoppers to customize items and view those items under different conditions), and to enhance other applications.

### SUMMARY

The present disclosure describes a device, computer-readable medium, and method for using augmented reality to improve visibility of traffic markers to assist drivers in navigating driving conditions in which the drivers'visibility may be impaired due to the traffic markers being occluded or obstructed. A method performed by a processing system including at least one processor includes monitoring at least one environmental condition surrounding a vehicle, using at least one on-board sensor of the vehicle, detecting that the at least one environmental condition surrounding the vehicle is likely to impair a visibility for an occupant of the vehicle, based on an output of the at least one on-board sensor, acquiring static map data for a location surrounding the vehicle, generating an augmented reality view of the location surrounding the vehicle, using the static map data for highlighting at least one traffic marker at the location surrounding the vehicle, and displaying the augmented reality view of the location surrounding the vehicle with the at least one traffic marker being highlighted on a display within the vehicle.

In another example, a non-transitory computer-readable storage medium stores instructions which, when executed by a processing system including at least one processor, cause the processing system to perform operations. The operations include monitoring at least one environmental condition surrounding a vehicle, using at least one on-board sensor of the vehicle, detecting that the at least one environmental condition surrounding the vehicle is likely to impair a visibility for an occupant of the vehicle, based on an output of the at least one on-board sensor, acquiring static map data for a location surrounding the vehicle, generating an augmented reality view of the location surrounding the vehicle, using the static map data for highlighting at least one traffic marker at the location surrounding the vehicle, and displaying the augmented reality view of the location surrounding the vehicle with the at least one traffic marker being highlighted on a display within the vehicle.

In another example, a system includes a processing system including at least one processor and a non-transitory computer-readable storage medium storing instructions which, when executed by the processing system, cause the processing system to perform operations. The operations include monitoring at least one environmental condition surrounding a vehicle, using at least one on-board sensor of the vehicle, detecting that the at least one environmental condition surrounding the vehicle is likely to impair a visibility for an occupant of the vehicle, based on an output of the at least one on-board sensor, acquiring static map data for a location surrounding the vehicle, generating an augmented reality view of the location surrounding the vehicle, using the static map data for highlighting at least one traffic marker at the location surrounding the vehicle, and displaying the augmented reality view of the location surrounding the vehicle with the at least one traffic marker being highlighted on a display within the vehicle.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for using augmented reality to improve visibility of traffic markers to assist drivers in navigating driving conditions in which the drivers'visibility may be impaired due to the traffic markers being occluded or obstructed may operate;

FIG. 2 illustrates a flowchart of an example method for using augmented reality to improve visibility of traffic markers to assist drivers in navigating driving conditions;

FIG. 3A illustrates an example in which there is heavy fog ahead of a car, obscuring visibility of a part of the road through the car's windshield;

FIG. 3B illustrates an augmented reality view of the road of FIG. 3A, in which traffic markers hidden by the fog may be digitally highlighted so that the traffic markers on the road become visible;

FIG. 4 illustrates a flowchart of another example method for using augmented reality to improve visibility of traffic markers to assist drivers in navigating driving conditions; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides systems, non-transitory computer-readable media, and methods for using augmented reality to improve visibility of traffic markers to assist drivers in navigating driving conditions in which the drivers'visibility may be impaired due to the traffic markers being occluded or obstructed. As discussed above, augmented reality (AR) is a specific instance of extended reality technology in which computer-generated virtual objects may be inserted into a view of a real world environment. For instance, a computer generated overlay may be superimposed over an image of a real world environment in order to present an AR experience. Thus, AR may be used to provide immersive entertainment experiences (e.g., gaming, movies, or the like), to simulate conditions for training exercises (e.g., for emergency responders, medical personnel, or the like), to improve e-commerce experiences (e.g., by enabling shoppers to customize items and view those items under different conditions), and to enhance other applications.

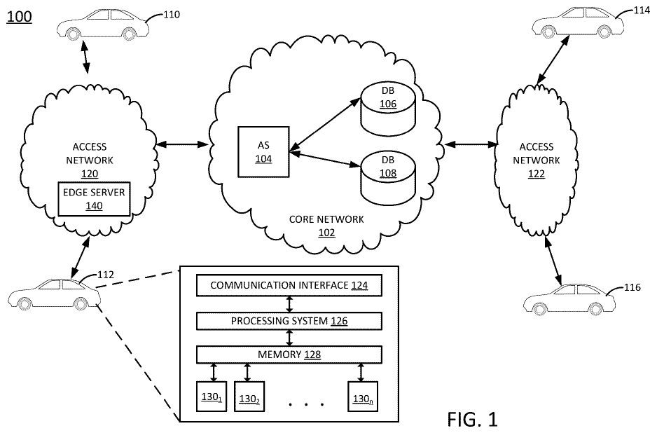

Examples of the present disclosure use AR technology to assist drivers during hazardous driving conditions in which the drivers'visibility may be impaired. For instance, weather events such as rain, snow, sleet, and fog, and other environmental conditions such as smoke from forest fires, heavy vehicle exhaust, sand storms, car accidents, abandoned vehicles, road constructions, road maintenance events, and road obstructions may impair driver visibility and create a safety hazard. In one example of the present disclosure, traffic markers (e.g., “permanent” traffic markers such as traffic signal lights, flashing stop lights, lane markers and lines defining lanes on a road, roadway signs (e.g., highway exit signs, speed limit signs, warning signs, stop signs, yield signs, railroad crossing signs, etc.), and “temporary” traffic markers such as safety traffic cones, safety traffic triangles, safety traffic barrels, or safety traffic barriers), located in the environment surrounding a moving vehicle may be highlighted and displayed on an in-vehicle display (e.g., a heads-up display (HUD), a dashboard display, an AR-enabled windshield, AR-enabled personal eyewear (e.g., smart eye glasses and/or smart goggles), or the like) when the environmental conditions surrounding the vehicle are determined to potentially impede driver visibility. The AR-enabled highlighting of the traffic markers may be generated using static map data, such as historical street-level views of the environment surrounding the moving vehicle, as well as dynamic map data (e.g., dynamic road condition data, such as real-time traffic conditions as reported by a first responder vehicle, e.g., cameras of a police cruiser or a traffic enforcement cruiser). The AR-enabled highlighting of the traffic markers may be updated continuously based on movement of the moving vehicle and changes in the dynamic road condition data. Thus, the AR-enabled highlighting of the traffic markers may provide an enhanced view of the environment surrounding the moving vehicle that is obstructed by the conditions creating the impaired visibility, but still allows the driver to continue to operate the moving vehicle in a safe manner. These and other examples of the present disclosure are discussed in great detail below in connection with FIGS. 1-5.

To further aid in understanding the present disclosure, FIG. 1 illustrates an example system 100 in which examples of the present disclosure for using augmented reality to improve visibility of traffic markers to assist drivers in navigating driving conditions in which the drivers'visibility may be impaired may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, an enterprise network comprising infrastructure for computing and providing communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, and so forth.

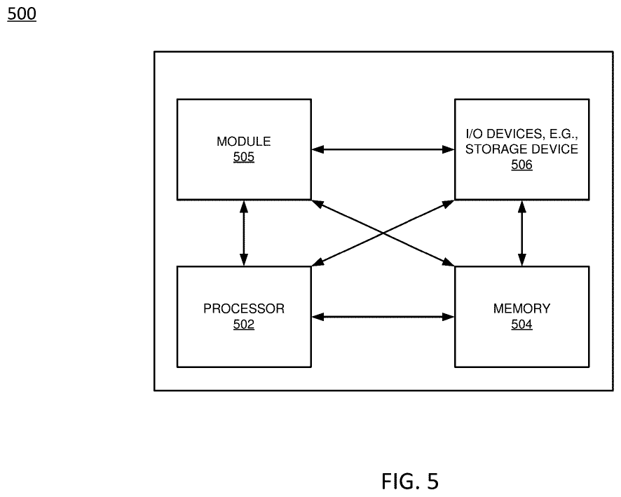

In accordance with the present disclosure, application server (AS) 104 may comprise a computing system or server, such as computing system 500 depicted in FIG. 5, and may be configured to provide one or more operations or functions for using augmented reality to improve visibility of traffic markers to assist drivers in navigating driving conditions in which the drivers'visibility may be impaired due to the traffic markers being occluded or obstructed. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

The AS 104 may be communicatively coupled to one or more databases (DBs) 106 and 108. The DBs 106 and 108 may store data that is used by the AS 104 to perform operations or functions for using augmented reality to improve visibility of traffic markers to assist drivers in navigating driving conditions in which the drivers'visibility may be impaired due to the traffic markers being occluded or obstructed, as described herein. For instance, the DB 106 may store outputs from the on-board sensors of a plurality of vehicles (e.g., outputs from the general public or outputs from first responder vehicles such as police and traffic vehicles), while DB 108 may store historical map data or current map data including street level views of a plurality of locations that will show one or more traffic markers. The DB 106 may be provided in connection with the AS 104 as part of a subscription service for using augmented reality to improve visibility of traffic markers to assist drivers, while the DB 108 may be provided as part of the subscription service or may be provided by a party that is unaffiliated with or independent of the subscription service, e.g., the information stored in DB 108 can be provided by a governmental agency, e.g., a weather forecasting entity (e.g., National Weather Service, National Oceanic, Atmospheric Administration, etc.) or an accident reporting entity (e.g., a local police department, a local fire department, a local ambulatory department, etc.) or a non-governmental agency that provides general mapping and/or street level viewing services. In one embodiment, the current map data may be updated with current reported roadway updates, e.g., current weather information affecting a roadway, current accident information affecting a roadway, current construction information affecting a roadway, current debris information affecting a roadway, etc. The current information may comprise specific time, roadway location and/or the exact nature of the roadway impairment, e.g., an image, or a video of the roadway impairment.

In a further example, AS 104 may comprise a physical storage device (e.g., a database server), to store various types of information in support of systems for generating data for using augmented reality to improve visibility of traffic markers to assist drivers in navigating driving conditions in which the drivers'visibility may be impaired due to the traffic markers being occluded or obstructed, in accordance with the present disclosure. For example, AS 104 may store any or all of the information stored by the DB 106 and/or DB 108.

Although only a single application server (AS) 104 and two databases (DBs) 106 and 108 are illustrated in FIG. 1, it should be noted that any number of servers and databases may be deployed. For instance, a plurality of servers and databases may operate in a distributed and/or coordinated manner as a processing system to perform operations for using augmented reality to improve visibility of traffic markers to assist drivers in navigating driving conditions in which the drivers'visibility may be impaired due to the traffic markers being occluded or obstructed, in accordance with the present disclosure. For ease of illustration, various additional elements of network 102 are omitted from FIG. 1.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

In one example, the access network 120 may be in further communication with a plurality of user endpoint devices (UEs), such as devices 110 and 112. Similarly, access network 122 may be in further communication with a plurality of user endpoint devices (UEs), such as devices 114 and 116. In one example, UEs 110-116 may each comprise a motor vehicle (e.g., a connected car, van, truck, trailer, construction vehicle, bus, or the like), and the like. In further examples, the UEs 110-116 may comprise other types of vehicles such as connected watercraft, aircraft, drone, and the like. By “connected,” it is understood that the vehicle is capable of communicating bidirectionally with external systems (i.e., systems external to the vehicle, including the AS 104 and/or DBs 106 and 108).

FIG. 1 illustrates a view of the UE 112 in more detail. The more detailed view of the UE 112 may also be representative of the UEs 110, 114, and 116; however, it is understood that any of the UEs 110, 112, 114, and 116 may include components in addition to those illustrated in FIG. 1. In one example, each UE 110-116 may comprise at least a communication interface 124, a processing system 126, a memory 128, and one or more on-board sensors 130₁-130ₙ (hereinafter individually referred to as an “on-board sensor 130” or collectively referred to as “on-board sensors 130”). The processing system 126 may be in communication with both the communication interface 124 and the memory 128, while the memory 128 may be in communication with the on-board sensors 130.

The on-board sensors 130 may include one or more different types of sensors for monitoring different conditions within and around a vehicle. In one example, the on-board sensors 130 may include at least one of: a sound navigation ranging (sonar) system, a light detection and ranging (lidar) system, a radar system, a camera (e.g., RGB and/or infrared video camera) system, a video camera, a global positioning system (GPS), a moisture sensor, a proximity sensor, a light sensor, a barometer, a thermometer, an anemometer, or another type of sensor. Each of the on-board sensors 130 may generate as an output measurements of a condition within or around the vehicle (e.g., on a continuous, periodic, or event-driven basis) and may store these measurements in the memory 128. In one example, measurements may remain in the memory 128 until the measurements reach a predefined age (e.g., z minutes) and/or until the measurements are overwritten by more recent measurements. The memory 128 may comprise volatile memory, non-volatile memory, read-only memory (ROM), random access memory (RAM), a magnetic or optical drive, a device or diskette, and/or any combination thereof.

The processing system 126 may comprise, in one example, an on-board computing system or controller of a vehicle (e.g., an electronic control unit (ECU) or an electronic control module (ECM)). The processing system 126 may retrieve measurements observed by the on-board sensors 130 from the memory 128 and may process the measurements in order to make inferences about the conditions surrounding the vehicle and conditions within the vehicle including an occupant's line of sight. For instance, if the measurements include camera images of the road ahead of the vehicle covered in heavy fog or smoke, then the processing system 126 may infer that the visibility of the vehicle's driver may be impaired. Similarly, if the measurements include outputs of a rainfall/snow sensor indicating that a threshold rate of rainfall or snow (e.g., x percentage of change in rainfall or snow depth over time) is occurring outside of the vehicle, then the processing system 126 may infer that the visibility of the vehicle's driver may be impaired. The processing system 126 may also obtain various measurements and infer the gaze or line of sight of one or more occupants within the vehicle, to control the highlighting of traffic markers using AR.

The communication interface 124 may comprise any type of interface to establish a wireless communication session with the access network 120 and core network 102. In one example, the communication interface 124 may be a wireless network card that can wirelessly connect to a local WIFI network. In one example, the communication interface, e.g., a transceiver, may establish a communication session between the vehicle and the DBs 106 or 108 in order to transmit measurements observed by the on-board sensors 130 from the memory 128 to the DB 106 and also to receive information and data from the DBs 106 or 108.

In a further example, when the processing system 126 infers that the visibility of the vehicle's driver is likely to be impaired by the conditions surrounding the vehicle, the communication interface 124 may establish a communication session between the vehicle and the AS 104 in order to acquire data to assist the processing system 126 in generating an AR view of the conditions surrounding the vehicle. More specifically, the acquired data will allow the processing system 126 to generate the AR view that uses augmented reality to improve visibility of traffic markers to assist drivers in navigating driving conditions in which the drivers'visibility may be impaired due to the traffic markers being occluded or obstructed (e.g., an AR view where traffic markers such as the lane markers that define the roadway lanes or lines, traffic signs and/or any obstructions (e.g., traffic cones or debris) are virtually highlighted (e.g., a virtual image of the relevant traffic markers are superimposed or overlaid onto the display or windshield of the vehicle). This AR view may be displayed on a display inside the vehicle, such as a heads up display, a dashboard display, an AR-enabled windshield, or the like. Thus, the AR view may help the driver to safely navigate the vehicle despite the inclement conditions.

It should also be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In one example, the system 100 may further include wireless or wired connections to sensors, radio frequency identification (RFID) tags, or the like from which devices may determine locations/positions, ranges/distances, bearings, and so forth. Thus, these and other modifications are all contemplated within the scope of the present disclosure.

In one embodiment, the gaze or line of sight of the occupant(s) of the vehicle will be tracked using one or more internal sensors, e.g., one or more cameras and infrared or near-infrared illuminating sources, facing into the cabin of the vehicle. For example, the gaze of the driver or a passenger sitting next to the driver will be tracked to determine their line of sights. In this illustrative embodiment, the line of sight of an occupant of the vehicle will allow the proper placement of a projection of an image onto a vehicle's windshield or a panel just beneath an occupant's line of sight, e.g., a projection from a heads-up display unit on the vehicle. In other words, the projection of the image by the heads-up display unit onto the vehicle's windshield can be continuously adjusted to accommodate the occupant's shifting gaze. In one embodiment, the projection includes the highlighting of the traffic markers. Thus, as the occupant's gaze is shifting, the projection including the highlighting of the traffic markers is also shifted in the same direction in a coordinated manner so the occupant will be able to see the highlighted traffic markers.

Various gaze tracking methods can be used, where gaze tracking is a method to monitor eye activity (e.g., of an occupant of the vehicle), including eye movements, point of gaze, pupil dilation, blinking, etc. Such method relies on eye tracking devices that use sensors to follow the eyes'movement and determine where a person is looking at (e.g., the point of gaze). In other words, eye tracking identifies and monitors a person's visual attention in terms of location, objects, and duration. For example, eye tracking may operate by following the eye position and movements in a non-intrusively manner. In one example, a source of infrared light can be used to illuminate the pupil, where a reflection is generated on the cornea. An infrared camera can then be used to record the reflection, determine the center of the pupil, determine eye rotation, thereby determining the gaze direction.

In other words, the vehicle (e.g., vehicle 112) may be equipped with one or more sensor clusters that are positioned so as to be able to sense an occupant's face (e.g., the vehicle operator's face). In one embodiment, the sensors (130₁-130ₙ) in a cluster may include video cameras, audio microphones, image cameras, sonar sensors, light detection and ranging (lidar) sensors, or other such sensors that may be used to detect the distance of the face from the sensor cluster. This sensor cluster is in communication with the onboard computer or processing system 126 or an edge server 140 deployed at the edge of the access network 120. The sensor cluster may continuously deliver sensor readings to the processing system 126 and/or the edge server 140 for analysis. For example, the processing system 126 and/or the edge server 140 may be equipped with a software application to analyze video along with sonar or other data that is indicative of the user's distance from the sensor cluster. In doing so, the processing system 126 and/or the edge server 140 may determine the location of each of the occupant's eyeballs within the cabin of the vehicle along with the direction of view of each eyeball at any given point in time. In one embodiment, the locations of one or more sensors of the sensor cluster within the cabin are known and predefined. Therefore, the sensor cluster or the processing system 126 will know the sensor cluster's location in three dimensions at any point in time. Therefore, the location in three dimensions of each eyeball may also be determined at any point in time as well, based on the sonar, light detection and ranging (lidar) or other such sensor data.

Furthermore, the cameras located in the sensor cluster may also send video to the processing system 126 and/or the edge server 140 which may also have image analysis capabilities so as to detect the orientation of the occupant's line of sight with respect to the location of each eyeball by detecting the orientation of the pupil of each eyeball. Using this data, the processing system 126 and/or the edge server 140 may detect a focal point at any given point in time for the occupant (e.g., relative to a point on the fixed windshield of the vehicle). This calculated focal point in three dimensions relative to the windshield display can be used to control the placement of the projection(s) or overlay(s) of the heads-up display unit to follow the gaze(s) of the occupant(s) (e.g., a driver and/or a passenger sitting in the front seat next to the driver). In one embodiment, two heads-up display units can be deployed to provide two separate distinct projects (one projection for the driver and another projection for a passenger sitting in the front seat next to the driver). This arrangement will allow each of the two occupants to follow his or her own heads-up display unit's projection or overlay, thereby enabling a passenger next to the driver to assist the driver if the driver is having trouble seeing outside of the windshield due to the inclement weather conditions, where both projections are augmented with the present AR-enabled highlighting of the traffic markers.

It should be noted that the focal point of each occupant may change frequently, therefore, data is continually fed from the sensor cluster to the processing system 126 and/or the edge server 140 so the focal point is continually monitored and calculated. Since the three dimensional coordinates of the source point of view are known (which may be determined to be the center point between the two eyeballs), the direction of an occupant's view, which is a line of sight from the source point of view to the focal point can be continually tracked, thereby allowing the present method to adjust the placement of the projection or overlay from the heads-up display unit relative to the fixed windshield of the vehicle.

In one embodiment, the edge server 140 can be tasked with making the various calculations discussed above for the processing system 126 if the vehicle has a processing system 126 that has limited processing capability. The placement of the edge server 140 at the edge of the access network 120 allows the communication network service provider to efficiently and quickly provide the present AR-enabled highlighting of the traffic markers as a service to the occupant of the vehicle. Since the vehicle may be travelling at a high rate of speed, the AR-enabled highlighting of the traffic markers must also be generated and presented on the projections of the heads-up display in a timely manner. By situating the edge server 140 at the edge of the access network 120, the calculated information can be delivered to the processing system 126 as quickly as possible. Pertinent map data can also be stored locally in the edge server 140 (e.g., pre-fetched) via communication with the DBs 106 and 108, thereby allowing the edge server 140 to quickly download the pertinent map data to a moving vehicle.

In one embodiment, the various sensors 130, including the cameras, on the vehicle, may be used to create a composite view of the surroundings of the vehicle 112. Since these camera locations are also fixed in relationship to the sensor arrays or clusters, the positioning of the images used to create the models of the surroundings are known in relation to the user's focal point on the windshield. Accordingly, with the relative location points known, the cameras may be used to sense the surroundings and, via image detection and analysis, identify where objects in the surroundings exist and what they are. For example, image analysis may be used to determine where lane markers are in the camera images. Knowing the positional relationship between the location of these lane markers and the relative focal point and direction of view of the driver, the processing system 126/edge server 140 may calculate and determine where on the vehicle's windshield to display augmented reality images (e.g., a projection or an overlay) that are representative of the items detected, such as lane markings, in such a way as for these lane markings to appear on the augmented reality display as though these lane markings were overlaying the actual lane markings as they relate to the view of the driver at that point in time.

In a like manner, the image analysis algorithm in the processing system 126/edge server 140 may detect objects such as pylons, safety cones or other safety markers and present a visualization (e.g., an animated, augmented, and highlighted version of these traffic markers) in an overlay fashion to their actual location as it relates to the driver's point of view. Similarly, moving objects such as vehicles or pedestrians or other potential hazards may also be detected and presented on the heads up display of the dashboard in an augmented and highlighted manner. However, one aspect of the present disclosure is the focus of the traffic markers to be highlighted. As such, any data not specifically pertaining to traffic markers can be ignored by the image analysis algorithm. For example, an image may contain a street with a stop sign and many surrounding buildings and trees on adjacent sidewalks. In one embodiment of the present disclosure, the image analysis algorithm in the processing system 126/edge server 140 may only apply processing resources to detect objects that resemble traffic markers such as the road itself and the stop sign. The image analysis algorithm may ignore the surrounding buildings and trees since such objects are not relevant in the present implementation for using augmented reality to improve visibility of traffic markers to assist drivers in navigating driving conditions in which the drivers'visibility may be impaired due to the traffic markers being occluded or obstructed.

In one embodiment, one or more microphones in the sensor cluster may also detect spoken utterance requests from the driver as these utterances relate to the driver's field of view (e.g., “raise the HUD projection,” “lower the HUD projection,” “highlight a particular traffic marker (e.g., “show me only the signage for Exit 12,” “show me only the lane markers on the roadway,” etc.),” or “de-highlight a particular traffic marker” (e.g., “do not show me any signage of the roadway”). That is, since there is now an association between the driver's focal point and viewable objects that correlate to the focal point, the image analysis and visualization capabilities of the processing system 126/edge server 140 may detect the presence of an item such as a directional sign. Using the focal point detection capabilities described in this present disclosure, the driver may issue a verbal command (and based on the time at which the command is issued) that can be correlated to an item that was detected as being in the driver's focal point. Upon receiving the spoken command, the sensor cluster may send a request to the processing system 126/edge server 140 to pull the virtual image from the current visualization that is created and presented on the heads up display.

In some cases, the present solution may not be able to rely only on the information sensed by onboard sensors of the vehicle. For example, in attempting to augment lane markers for a snowy road, the cameras on board the vehicle may not be able to sense the existing lane markers due to an obstructed view (e.g., the lane markers being totally covered by snow for an extended distance, e.g., the snow covered roadway has not been plowed yet).

To illustrate, the edge server 140 may also be tasked with providing supplementary information to the processing system 126 in certain scenarios. For example, the edge server 140 may provide the supplementary information comprising at least one of: 1) roadway lane marker data (that defines the lane lines on the road way), 2) roadway sign data (that defines the various signage on the road way, e.g., such as warning signs and exit signs), 3) roadway construction data (that defines the various roadway constructions on the road way, e.g., the type of construction), 4) roadway accident data (that defines any accidents on the roadway, e.g., the type of accidents such as car crashes, a car hitting an animal, a car leaving the roadway, a car on fire, a stalled car on the shoulder of the roadway, etc.), 5) roadway debris data (that defines any known debris on the roadway e.g., the type of debris such as a tire, a discarded safety cone, an animal, a tree limb, a rock, etc.), and the like. Such supplementary information may include the location (e.g., Global Positioning System (GPS) location information), the type, and/or the condition of any known objects or surface conditions of the roadway (e.g., for a stretch of roadway ahead of the vehicle, e.g., data for up to one mile, two miles, or three miles ahead of the vehicle). If the supplementary information is provided with sufficient accuracy (e.g., location, shape and size), the processing system 126 will be able to use the data contained in the supplementary information via augmented reality to improve visibility of traffic markers to assist drivers in navigating driving conditions in which the drivers'visibility may be impaired due to the traffic markers being occluded or obstructed. In one embodiment, the edge server 140 is in communication with DBs 106 and 108 to obtain the necessary supplementary information to support the vehicle 112 given the vehicle's current location and its trajectory. In one embodiment, the edge server 140 may perform pre-processing on the supplementary information received from the DBs 106 and 108, where non-pertinent data in the supplementary information such as surrounding buildings and the background landscape can be removed (e.g., the non-pertinent objects being identified and segmented out from the image or the image size of the image can be cropped to not contain such non-pertinent objects) to reduce the size of the supplementary information that will be sent to the moving vehicle, thereby effecting a faster processing of the supplementary information for highlighting the relevant traffic markers for the driver of the moving vehicle.

In one example, the processing system 126/edge server 140 may send a query to an external database (e.g., DBs 106 and/or 108) that stores a record of locations of markers. This database may have been populated at a previous time, for example, by a vehicle or other devices that mapped the location and conveyed coordinate data of the lane markers, road signs, and other roadway fixtures.

In a similar manner, the augmented reality heads up display via the processing system 126 may be used or controlled to provide a projection for directional guidance indicators that are not sensed by onboard sensors such as cameras or others, but may be in response to specific broadcast instructions from a local guidance server, for example, that may be used to dictate a dynamic usage of a particular transport area such as a busy bridge. As an example, the bridge may have three inbound lanes and three outbound lanes to a city. During the morning rush hours, one of the outbound lane is converted to an inbound lane to handle the higher inbound traffic in the morning (i.e., resulting in two outbound lanes and four inbound lanes). Alternatively, during the evening rush hours, one of the inbound lane is converted to an outbound lane to handle the higher outbound traffic in the evening (i.e., resulting in two inbound lanes and four outbound lanes). In other words, the use of the roadway may be dynamically changed in terms of how many lanes are created and in which direction they will be allowed for travel. This type of road use may be dynamic and based on a number of current condition factors, such as weather, traffic patterns, nearby events that will cause higher volumes of traffic, and others. During inclement weather or impaired vision scenarios, this dynamic road usage may create very significant hazards, e.g., where the driver does not see the overhead red light for a lane indicating that the lane the driver is traveling on is currently closed to traffic from the driver's current direction. In one embodiment, this supplementary information (e.g., dynamic roadway lane assignment) may be sent from the local guidance server and presented on the augmented heads up display of the present disclosure.

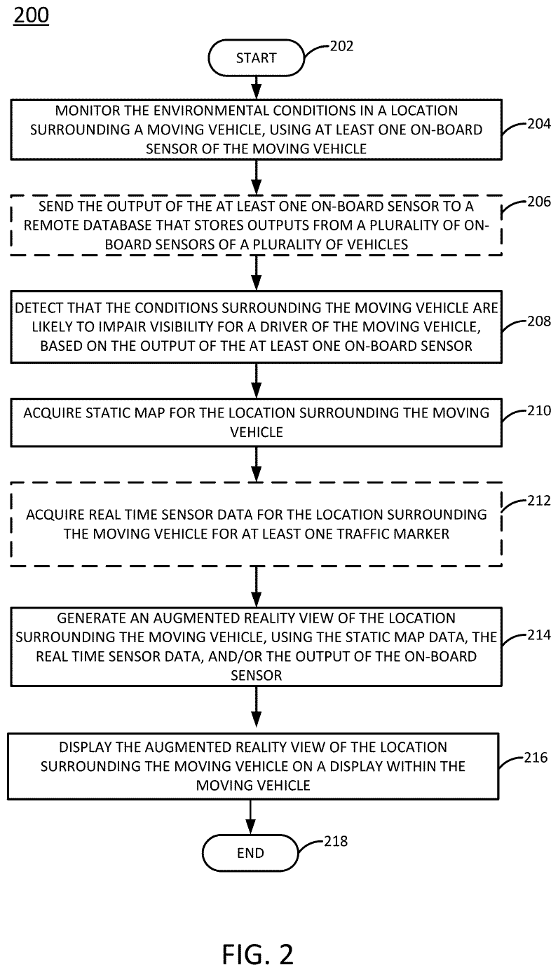

FIG. 2 illustrates a flowchart of an example method 200 for using augmented reality to improve visibility of traffic markers to assist drivers in navigating driving conditions in which the drivers'visibility may be impaired due to the traffic markers being occluded or obstructed. The steps, functions, or operations of the method 200 may be performed, for example, by the processing system of a vehicle, such as the processing system 126 illustrated in FIG. 1. In another example, the steps, functions, or operations of method 200 may be performed by a computing device or system 500, and/or processor 502 as described in connection with FIG. 5 below. Similarly, in one example, the steps, functions, and/or operations of the method 200 may be performed by a processing system comprising one or more computing devices collectively configured to perform various steps, functions, and/or operations of the method 200. For instance, multiple instances of the computing device or processing system 500 may collectively function as a processing system. For illustrative purposes, the method 200 is described in greater detail below in connection with an example performed by a processing system, such as processor 502.

The method 200 begins in step 202. In step 204, the processing system may monitor the environmental conditions surrounding a moving vehicle, using at least one on-board sensor of the moving vehicle. In one example, the moving vehicle may include a plurality of on-board sensors that measure different environmental conditions of and around the moving vehicle and provide measurements of the different environmental conditions to the processing system. In one example, the on-board sensors may include at least one of: a sonar system, a lidar system, a radar system, a camera (e.g., RGB and/or infrared video camera) system, a GPS, a moisture sensor, a proximity sensor, a light sensor, a barometer, a thermometer, an anemometer, or another type of sensor. The measurements provided by any of these on-board sensors may be analyzed by the processing system in order to detect the presence and location of weather events, other objects (e.g., other vehicles, pedestrians, road obstructions, etc.), and the like, as discussed in greater detail below.

In optional step 206 (illustrated in phantom), the processing system may send the output of the at least one on-board sensor to a remote database that stores outputs of a plurality of on-board sensors of a plurality of vehicles. In one example, a remote database (e.g., DB 106 or 108) may collect measurements from the on-board sensors of a plurality of vehicles (which may include moving and non-moving vehicles), where each vehicle of the plurality of vehicles may include on-board sensors such as those described above. In one example, each measurement (including the output of the on-board sensor that is sent by the processing system) may include metadata identifying at least one of: a location at which the measurement was measured (e.g., GPS coordinates, longitude and latitude, highway exit markers, street names, zip codes, city, landmarks (e.g., bridges, tunnels, toll booths, railroad stations, and the like), or other positional identifiers), a time at which the measurement was measured, a vehicle from which the measurement was received (e.g., a unique identifier that identifies a single vehicle), and/or other information.

In one example, users may opt into sharing the outputs of their vehicles'on-board sensors with the remote database, e.g., as part of a subscription-based service. For instance, users may subscribe to a service whereby the users'vehicles are assigned unique identifiers. Subsequently, when the users are operating their vehicles, data measured by the on-board sensors of the vehicles may be marked with the vehicles unique identifiers and shared with the remote database. When necessary, data measured by the on-board sensors of other vehicles may be shared by the database with the vehicles, as discussed in greater detail below.

In step 208, the processing system may detect that the conditions surrounding the moving vehicle are likely to impair visibility for a driver of the moving vehicle, based on the output of the on-board sensor. In one example, the processing may automatically detect that the conditions surrounding the moving vehicle are likely to impair visibility for the driver in response to the detection of at least one predefined condition in the output of the on-board sensor. For instance, a rainfall sensor may detect the presence of a predefined threshold rate of rainfall (e.g., x percentage of change in rainfall depth over time), a camera may detect a predefined threshold decrease in visibility (e.g., inability to identify objects located a threshold distance away with a threshold degree of confidence) caused by fog or snow, or the like.

In another example, the processing system may detect that the conditions surrounding the moving vehicle are likely to impair visibility for the driver in response to receiving a signal from a user (e.g., driver or passenger) of the moving vehicle. For instance, the user may press a button, speak a keyword, or otherwise provide a signal to let the processing system know that an AR view of the environment surrounding the moving vehicle is being requested.

In another example, the processing system may detect that the conditions surrounding the moving vehicle are likely to impair visibility for the driver in response to receiving an alert from a remote server or other devices. For instance, although the conditions currently surrounding the moving vehicle may not substantially impair driver visibility, the moving vehicle may be approaching a location at which the conditions are different (e.g., a location at which there is a fire producing large amounts of smoke, a localized heavy rain storm, a localized sand storm, a vehicular accident, or the like). A local guidance server may also have implemented a dynamic roadway lane assignment on a bridge that may change a lane assignment that is not normal for the bridge. In such a case, if the vehicle is inferred to be approaching the location at which the conditions are different (e.g., based on a destination programmed into a navigation system, on current direction of travel, or the like), then a server or another device that is aware of the conditions and of the moving vehicle's location and/or inferred route may transmit an alert to the moving vehicle.

In step 210, the processing system may acquire static map data for the location surrounding the moving vehicle. In one example, the static map data may be obtained from a remote server (e.g., a map generation server). For instance, the remote server may retrieve the static map data from one or more databases, where each database of the one or more databases may be operated by a different entity (e.g., a commercial entity, a governmental entity, an educational entity, or the like). In one example, the static map data stored in the databases may comprise maps and/or images of a plurality of locations having permanent traffic markers, where the static map data does not change substantially over time. For instance, the static map data may comprise historical street level views or images of the location surrounding the moving vehicle with permanent traffic markers such as roadway lane lines, stop signs, yield signs, exit signs, traffic lights, and so on. The term “permanent” refers to traffic markers that are not dynamically moved on a regular basis, e.g., the traffic markers are installed in the locations for many months or years.

In optional step 212, the processing system may acquire dynamic map data. In one example, the dynamic map data stored in the databases may comprise maps and/or images of a plurality of locations having temporary traffic markers, where the dynamic map data will change substantially over time. For instance, the dynamic map data may comprise historical street level views or images of the location surrounding the moving vehicle with temporary traffic markers such as temporary traffic safety markers (e.g., traffic safety cones, triangles, or barrels deployed by first responders or drivers of other vehicles involved in a car accident), temporary car accident debris (e.g., crashed vehicles or parts of the crashed vehicles), temporary environmental debris (e.g., a landslide, fallen rocks or boulders, fallen trees or tree limbs, etc.), temporary weather related debris (e.g., debris left on a roadway from a storm like a hurricane) and so on.

More specifically, optional step 212 may acquire real time sensor data for the location surrounding the moving vehicle, where the real time (e.g., dynamic) sensor data comprises outputs of a plurality of on-board sensors of a plurality of other vehicles (i.e., vehicles other than the moving vehicle). In one embodiment, it should be noted that “real time” sensor data may comprise “near real time” sensor data relative to the perspective of a current vehicle, e.g., within a predefined amount of time occurring before the current time. For example, an earlier vehicle travelling on the same roadway ahead of a current vehicle (e.g., one minute ahead, two minutes ahead, five minutes ahead, and so on). Alternative, in another embodiment, the other vehicles may simply be other vehicles traveling alongside a current vehicle, but these other vehicles may have a slightly different locations (i.e., different perspectives) relative to the current vehicle (e.g., in neighboring lanes on a multi-lane highway, etc.), where “real time” sensor data can be acquired (e.g., images from a vehicle travelling on a local lane may reveal an accident ahead more clearly than images taken from a vehicle travelling on an express lane).

In one example, the real time sensor data may be acquired from the remote server from which the static map data was obtained in step 210. For instance, the remote server may retrieve the real time sensor data from a remote database, such as the database (e.g., DB 106 or DB 108) to which the processing system sent via the on-board sensor output in step 206. As discussed above, the real time sensor data stored in the remote database may comprise on-board sensor data collected from a plurality of vehicles, where the real time sensor data may change continuously over time. For instance, the real time sensor data may comprise data indicative of weather conditions (e.g., precipitation, wind, or the like), traffic conditions (e.g., accidents, construction sites, obstructions, or the like), or other conditions. The real time sensor data may be associated with metadata indicating when (time) and where (location) the real time sensor data was measured or collected. In some examples, real time sensor data may age out of the remote database after a threshold period of time. For instance, all real time sensor data may be automatically deleted from the remote database after z minutes, e.g., z may be 5 minutes, 10 minutes, 15 minutes, 60 minutes, 120 minutes, etc. The real time sensor data may, however, continually be replaced in the remote database with more recent real time sensor data.

In another example, the real time sensor data may be obtained directly from the plurality of vehicles. For instance, direct vehicle-to-vehicle communications (peer-to-peer communication) may allow vehicles to share their respective real time sensor data directly, decreasing the latency with which the real time sensor data is acquired by the processing system.

In step 214, the processing system may generate an augmented reality view of the location surrounding the moving vehicle 112, using the static map data, the dynamic map data (e.g., real time sensor data of other vehicles 110, 114, or 116), and/or the output of the at least one on-board sensor. In one example, the augmented reality view may comprise a view of the location surrounding the moving vehicle where AR-enabled highlighting of the traffic markers is provided. “Highlighting” of the traffic markers may comprise creating and presenting a virtual image of the traffic marker, e.g., creating and displaying a virtual roadway lane line when the actual roadway lane line is covered by an obstruction, e.g., rain water, snow, sleet, or fog. Alternatively, “highlighting” of the traffic markers may comprise creating and presenting a virtual image effect surrounding a real traffic marker, e.g., creating and displaying a virtual overlay color, shading, or vibrating effect over an actual roadway lane line is partially covered by an obstruction, e.g., rain water, snow, sleet, or fog. In other words, if the actual traffic marker is still partially visible, the “highlighting” of the traffic marker may only require an emphasizing effect to be placed over the actual traffic marker without having to create and superimpose a virtual traffic marker onto a virtual projection. For instance, the augmented reality view may present a video image of the roadway ahead of the moving vehicle, where the video image may be digitally altered to highlight one or more traffic markers that are likely to be obstructed and impaired from being viewed by an occupant of the vehicle. As an example, if the moving vehicle is driving through an area of heavy fog, the augmented reality view may comprise a video image of the roadway ahead of the moving vehicle, but with the fog covered lane markers being highlighted. This may help the driver to navigate the moving vehicle through the area of heavy fog, even though the driver's visibility may be impaired.

In step 216, the processing system may display the augmented reality view of the location surrounding the moving vehicle on a display within the moving vehicle. For instance, the moving vehicle may include a heads up display, a dashboard display, an AR-enabled windshield, or another type of display on which the AR view may be displayed to the driver of the moving vehicle. As discussed above, this may help the driver to navigate the moving vehicle through the conditions that are impairing visibility.

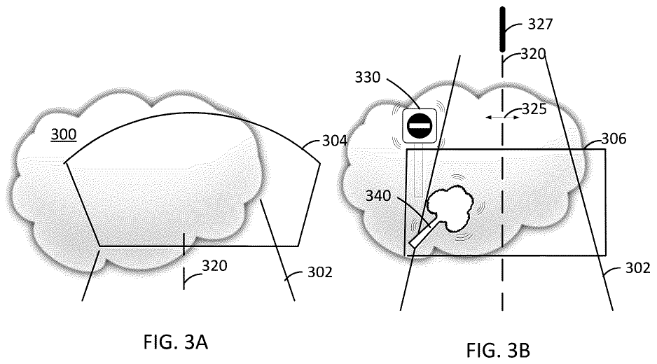

FIG. 3A, for instance, illustrates an example in which there is heavy fog 300 ahead of a car, obscuring visibility of part of the road 302 through the car's windshield 304. FIG. 3B illustrates an AR view 306 of the road 302 of FIG. 3A, in which the fog covered traffic markers may be digitally highlighted so that the fog covered traffic markers 320, 330, and 340 are made more visible. For example, part of the roadway lane line 320 may become occluded by the fog as the vehicle is travelling down the roadway as shown in FIG. 3A. When the present AR-enabled highlighting of the traffic markers is activated, the part of the roadway lane line 320 that is occluded by the fog as shown in FIG. 3A is now presented with an AR projection showing a virtual traffic marker that extends the roadway lane line 320 as shown in FIG. 3B. In one embodiment, the virtual traffic marker is provided with a second highlighting effect 325, e.g., where the virtual traffic marker is slightly vibrating or shifting left and right to further highlight the virtual traffic marker, or a highlighting effect 327 where the virtual traffic marker is highlighted with a color or a change in thickness or width of the virtual traffic marker. Furthermore, signage 330 (e.g., a Do Not Enter sign or a Lane Not In Use sign) may be virtually created and provided in the projection. Similarly, debris 340 (e.g., a temporary obstruction such as a downed tree) may be virtually created and provided in the projection. Similarly, the virtual traffic markers for the signage 330 and the debris 340 can also be provided with a second highlighting effect such as a flashing overlay color painted over the downed tree or the Do Not Enter sign. Thus, the AR view 306 may be displayed on a display within the car, as discussed above.

Steps 204-216 may be repeated as necessary, e.g., such that the AR view continually presents a modified view of the road ahead of the moving vehicle until the conditions surrounding the moving vehicle change to allow improved visibility, until the moving vehicle reaches a destination programmed into a navigation application, until the engine of the moving vehicle is shut off, until a user of the moving vehicle requests that the AR view be turned off, or until another predefined event is detected to have occurred. The method 200 may end in step 218.

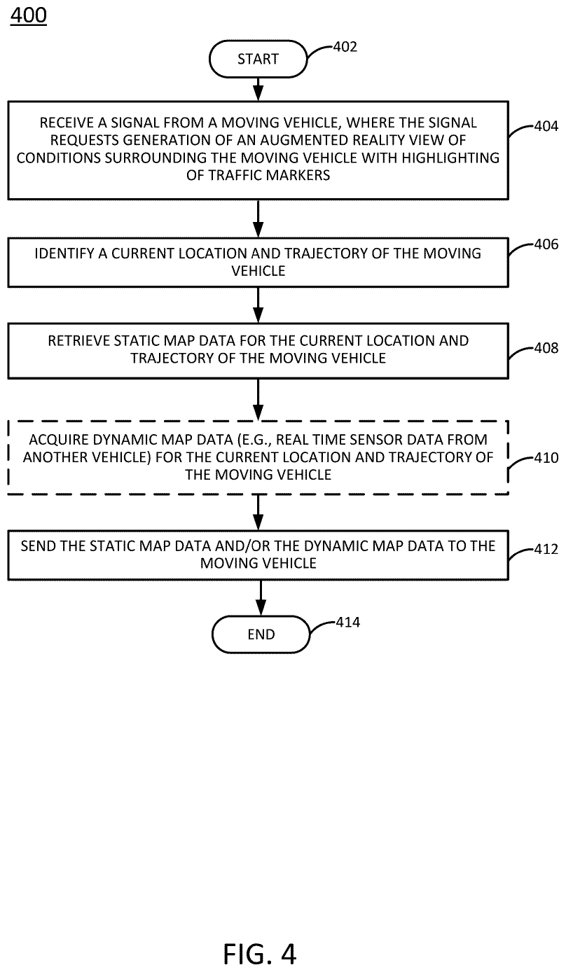

FIG. 4 illustrates a flowchart of an example method 400 for providing augmented reality maps (e.g., static map data and/or dynamic map data) to assist drivers in navigating driving conditions in which the drivers'visibility may be impaired, e.g., to control the highlighting of traffic markers using AR. The steps, functions, or operations of the method 400 may be performed, for example, by an application server, such as the AS 104 illustrated in FIG. 1. In another example, the steps, functions, or operations of method 400 may be performed by a computing device or system 500, and/or processor 502 as described in connection with FIG. 5 below. Similarly, in one example, the steps, functions, and/or operations of the method 400 may be performed by a processing system comprising one or more computing devices collectively configured to perform various steps, functions, and/or operations of the method 400. For instance, multiple instances of the computing device or processing system 500 may collectively function as a processing system. For illustrative purposes, the method 400 is described in greater detail below in connection with an example performed by a processing system, such as processor 502.

The method 400 begins in step 402. In step 404, the processing system may receive a signal from a moving vehicle, where the signal requests generation of an augmented reality view of conditions surrounding the moving vehicle with highlighting of traffic markers. Alternatively, the signal may request the pertinent data to allow the moving vehicle itself to generate the augmented reality view of conditions surrounding the moving vehicle with highlighting of traffic markers.

As discussed above, the processing system of a moving vehicle may automatically request generation of an AR view when the processing system detects that the conditions surrounding the moving vehicle are likely to impair visibility for the driver of the moving vehicle. In another example, the processing system of the moving vehicle may proactively request generation of an AR view when the processing system of the moving vehicle infers (e.g., based on data from another data source, such as another vehicle, a news feed, an emergency alert, or a weather forecasting application) that the moving vehicle will soon enter conditions in which the visibility may be impaired for the driver. In another example, a user (e.g., the driver or a passenger) of the moving vehicle may dynamically request the AR view.

In step 406, the processing system may identify a current location and trajectory of the moving vehicle. In one example, the current location and trajectory of the moving vehicle may be included in the request received in step 404. For instance, metadata associated with the request may indicate the current location (e.g., GPS coordinates, longitude and latitude, highway exit markers, street names, zip codes, city, landmarks, or other positional identifiers) of the moving vehicle and the moving vehicle's trajectory (e.g., a path to a destination that has been programmed into a navigation application, a predefined distance ahead on a road currently traveled by the moving vehicle, etc.).

In another example, the processing system may identify the current location and trajectory of the moving vehicle by first identifying the moving vehicle. For instance, if the moving vehicle is subscribed to an AR assisting service, then the moving vehicle may be associated with a unique account number or other vehicle identifiers. The vehicle identifier may be used as an index to a database that stores real time sensor data for a plurality of vehicles subscribed to the AR assisting service. For instance, each instance of real time sensor data stored in the database may be tagged with metadata to indicate the source of the instance of real time sensor data. The processing system may search the database for instances of real time sensor data for which the source is the moving vehicle, and may then identify from among those instances that real time sensor data that was recorded most recently in the database (e.g., has the most recent timestamp). This may give an approximation of the current location and trajectory of the moving vehicle by first identifying the moving vehicle.

In step 408, the processing system may retrieve static map data for the current location and trajectory of the moving vehicle with highlighting of traffic markers. In one example, the processing system may use the current location and trajectory of the moving vehicle (determined in any of the ways discussed above) as an index into a database that stores maps and/or images of a plurality of locations, where the static map data does not change substantially over time. For instance, the static map data may comprise historical street level views or images of the location surrounding the moving vehicle. The processing system may search the database for any static map data that is tagged with metadata that matches the current location and trajectory of the moving vehicle. More specifically, the static map data is specifically obtained to assist in the highlighting of traffic markers shown or displayed in the static map data.

In optional step 410, the processing system may acquire dynamic map data (e.g., real time sensor data from other vehicles) for the current location and trajectory of the moving vehicle, i.e., where the real time sensor data may comprise data measured by an on-board sensor of at least one other vehicle. In one example, the processing system may use the current location and trajectory of the moving vehicle (determined in any of the ways discussed above) as an index into a database that stores real time sensor data for a plurality of vehicles subscribed to the AR mapping service. For instance, each instance of real time sensor data stored in the database may be tagged with metadata to indicate the time and location at which the real time sensor data was recorded. The processing system may search the database for instances of real time sensor data for which the location matches the current location or the trajectory of the moving vehicle.

In step 412, the processing system may send the static map data and/or the dynamic map data (e.g., real time sensor data) to the moving vehicle. Alternatively, in one embodiment the processing system may generate and then send the augmented reality view of conditions surrounding the moving vehicle with highlighting of traffic markers to the moving vehicle. In other words, in one embodiment, the augmented reality view of conditions surrounding the moving vehicle with highlighting of traffic markers can be generated externally from the moving vehicle and then transmitted to the moving vehicle. Such embodiment can be achieved if there is sufficient transmission bandwidth between the moving vehicle and the application server 104 or edge server 140.

As discussed above, a processing system of the moving vehicle may use the static map data and/or the dynamic may data to generate an AR view of the environment surrounding the moving vehicle with highlighting of traffic markers, where the AR view may digitally highlight various traffic markers that may be occluded from the driver of the moving vehicle due to inclement conditions.

Steps 406-412 may be repeated as necessary, e.g., such that the processing system continually sends updated static map data and/or dynamic map data to the moving vehicle based on the movement of the moving vehicle, allowing the processing system of the moving vehicle to continually present a modified view of the road ahead of the moving vehicle with the highlighting of traffic markers until the conditions surrounding the moving vehicle change to allow improved visibility, until the moving vehicle reaches a destination programmed into a navigation application, until the engine of the moving vehicle is shut off, until a user of the moving vehicle requests that the AR view be turned off, or until another predefined event is detected to have occurred. The method 400 may end in step 414.

Although not expressly specified above, one or more steps of the method 200 or the method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 of FIG. 4 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 5 depicts a high-level block diagram of a computing device specifically programmed to perform the functions described herein. For example, any one or more components or devices illustrated in FIG. 1 or described in connection with the method 200 or method 400 may be implemented as the system 500. For instance, a connected vehicle or an application server could be implemented as illustrated in FIG. 5.

As depicted in FIG. 5, the system 500 comprises a hardware processor element 502, a memory 504, a module 505 for using augmented reality to improve visibility of traffic markers to assist drivers in navigating driving conditions in which the drivers'visibility may be impaired due to the traffic markers being occluded or obstructed, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for using augmented reality to improve visibility of traffic markers to assist drivers in navigating driving conditions in which the drivers'visibility may be impaired due to the traffic markers being occluded or obstructed may include circuitry and/or logic for performing special purpose functions relating to generating augmented reality maps. The input/output devices 506 may include, for example, a camera, a video camera, storage devices (including but not limited to, a tape drive, a floppy drive, a hard disk drive or a compact disk drive), a receiver, a transmitter, a speaker, a microphone, a transducer, a display, a speech synthesizer, a haptic device, a sensor, an output port, a display, an on-board sensor, a sonar sensor, a lidar sensor, or a user input device (such as a keyboard, a keypad, a mouse, and the like).

Although only one processor element is shown, it should be noted that the dedicated computer may employ a plurality of processor elements. Furthermore, although only one computer is shown in the FIG. 5, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for using augmented reality to improve visibility of traffic markers to assist drivers in navigating driving conditions in which the drivers'visibility may be impaired due to the traffic markers being occluded or obstructed (e.g., a software program comprising computer-executable instructions) can be loaded into memory 504 and executed by hardware processor element 502 to implement the steps, functions or operations as discussed above in connection with the example method 200 or example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for using augmented reality to improve visibility of traffic markers to assist drivers in navigating driving conditions in which the drivers'visibility may be impaired due to the traffic markers being occluded or obstructed (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a disclosed example should not be limited by any of the above-described examples, but should be defined only in accordance with the following claims and their equivalents.

What is claimed is:

1. A method comprising:
monitoring, by a processing system including at least one processor, at least one environmental condition surrounding a vehicle, using at least one on-board sensor of the vehicle;
detecting, by the processing system, that the at least one environmental condition surrounding the vehicle is likely to impair a visibility for an occupant of the vehicle, based on an output of the at least one on-board sensor;
acquiring, by the processing system, static map data for a location surrounding the vehicle;
generating, by the processing system, an augmented reality view of the location surrounding the vehicle, using the static map data for highlighting at least one traffic marker at the location surrounding the vehicle; and
displaying, by the processing system, the augmented reality view of the location surrounding the vehicle with the at least one traffic marker being highlighted on a display within the vehicle.

2. The method of claim 1, wherein the vehicle is a moving vehicle on a roadway.

3. The method of claim 1, wherein the at least one on-board sensor comprises at least one of: a sonar system, a light detection and ranging system, a radar system, a camera system, a global positioning system, a moisture sensor, a proximity sensor, a light sensor, a barometer, a thermometer, or an anemometer.

4. The method of claim 1, wherein the detecting is in response to a detection of a predefined condition in the output of the at least one on-board sensor.

5. The method of claim 1, wherein the detecting is in response to receiving a signal from an occupant of the vehicle.

6. The method of claim 1, wherein the detecting is in response to receiving an alert from a remote server.

7. The method of claim 1, wherein the static map data comprises historical street level views or images of the location surrounding the vehicle.

8. The method of claim 1, further comprising:
acquiring, by the processing system, dynamic map data for the location surrounding the vehicle.

9. The method of claim 8, wherein the dynamic map data comprises real time sensor data for the location surrounding the vehicle, where the real time sensor data comprises outputs of a plurality of on-board sensors of a plurality of other vehicles.

10. The method of claim 9, wherein the real time sensor data for the location surrounding the vehicle comprises at least one of: data indicative of weather conditions or data indicative of traffic conditions.

11. The method of claim 8, wherein the dynamic map data is acquired directly from another vehicle.

12. The method of claim 8, wherein the dynamic map data is acquired from a remote server in communication with a database that receives the dynamic map data from a plurality of other vehicles.

13. The method of claim 1, wherein the at least one traffic marker comprises roadway lane markers that are occluded, and wherein the highlighting comprises generating a virtual image in which virtual roadway lane markers are presented on the display.

14. The method of claim 1, wherein the at least one traffic marker comprises a signage that is occluded, and wherein the highlighting comprises generating a virtual image in which a virtual signage is presented on the display.

15. The method of claim 1, wherein the at least one traffic marker comprises a traffic light that is occluded, and wherein the highlighting comprises generating a virtual image in which a virtual traffic light is presented on the display.

16. The method of claim 8, wherein the at least one traffic marker comprises a roadway obstruction that is occluded, and wherein the highlighting comprises generating a virtual image in which a virtual roadway obstruction is presented on the display.

17. The method of claim 1, wherein the display comprises at least one of: a heads up display, a dashboard display, or an augmented reality-enabled windshield.

18. The method of claim 1, further comprising:
determining, by the processing system, a line of sight of the occupant; and
relocating, by the processing system, a position of the display in accordance with the line of sight of the occupant.

19. A non-transitory computer-readable storage medium storing instructions which, when executed by a processing system including at least one processor, cause the processing system to perform operations, the operations comprising:
monitoring at least one environmental condition surrounding a vehicle, using at least one on-board sensor of the vehicle;
detecting that the at least one environmental condition surrounding the vehicle is likely to impair a visibility for an occupant of the vehicle, based on an output of the at least one on-board sensor;
acquiring static map data for a location surrounding the vehicle;
generating an augmented reality view of the location surrounding the vehicle, using the static map data for highlighting at least one traffic marker at the location surrounding the vehicle; and
displaying the augmented reality view of the location surrounding the vehicle with the at least one traffic marker being highlighted on a display within the vehicle.

20. A system comprising:
a processing system including at least one processor; and
a non-transitory computer-readable medium storing instructions which, when executed by the processing system, cause the processing system to perform operations, the operations comprising:
monitoring at least one environmental condition surrounding a vehicle, using at least one on-board sensor of the vehicle;
detecting that the at least one environmental condition surrounding the vehicle is likely to impair a visibility for an occupant of the vehicle, based on an output of the at least one on-board sensor;
acquiring static map data for a location surrounding the vehicle;
generating an augmented reality view of the location surrounding the vehicle, using the static map data for highlighting at least one traffic marker at the location surrounding the vehicle; and
displaying the augmented reality view of the location surrounding the vehicle with the at least one traffic marker being highlighted on a display within the vehicle.
